(19) United States
(12) Patent Application Publication
(10) Pub. No.: US 2018/0031489 A1
(43) Pub. Date: Feb. 1, 2018

(54) INSPECTION APPARATUS

(71) Applicant: BAE SYSTEMS AUSTRALIA LIMITED, Edinburgh (AU)

(72) Inventor: James Murray Andrew WALDIE, Camberwell (AU)

(21) Appl. No.: 15/551,212

(22) PCT Filed: Jan. 29, 2016
(86) PCT No.: PCT/AU2016/050049

§ 371 Date: Aug. 15, 2017

(30) Foreign Application Priority Data
Feb. 23, 2015 (AU) 2015900629

(51) Int. Cl. G01N 21/88; G01J 1/42; G01J 1/44

(52) U.S. Cl. CPC G01N 21/88; G01J 1/44; G01J 1/4228

(57) ABSTRACT

An inspection apparatus for facilitating inspection of one or more relatively inaccessible inspection locations of a structure or second apparatus, the inspection apparatus including one or more guide sections mounted to the structure or second apparatus and configured to guide an inspection device along a path to access the inspection locations, and to allow inspection of the relatively inaccessible inspection locations of the structure or second apparatus by the inspection device.

### TECHNICAL FIELD

The present invention relates to an inspection apparatus, in particular for inspecting difficult to access locations of or within a structure or apparatus.

### BACKGROUND

There are many situations in which it is important to perform inspections at locations that are difficult or impossible to access directly by a person. For example, such locations may be deep within an apparatus or structure, possibly requiring navigation of a complex or tortuous path, and/or may be within a sealed or otherwise inaccessible enclosure, or may simply be remote from any location directly accessible by a person. Such inspections are not necessarily limited to visual inspections, but and include inspection using any one or more of a wide variety of different types of inspection devices or sensors, typically (but not necessarily) in combination with visual inspection.

For example, preventive maintenance inspections of a structure or apparatus are commonly conducted using a schedule-based inspection regime that is imposed by its manufacturer and/or by a regulatory body. Often this involves disassembling the structure/apparatus, finding nothing, and then reassembling. Such a necessary but fruitless exercise comes at the expense of wasted downtime, wasted inspector time, added cost, and sometimes the accidental production of maintenance-induced damage or faults. Conversely, sometimes it happens that significant and unforseen damage is unexpectedly found during an inspection, leading to extended platform downtime (often exacerbated by lead times for spare parts), higher than expected labour time and costs for repair, and a significant impact on total maintenance resources and operation.

In this regard, the burden of corrosion is becoming increasingly significant across a number of industries due to factors such as increased pressure to extend service life, operations in more severe environments, reduced effectiveness of environmentally-friendly corrosion inhibitors, increased OH&S requirements for access into dangerous spaces, overly rigorous mandated inspection regimes causing maintenance-induced damage, and other causes.

For example, defence forces are becoming increasingly concerned at the increasing cost and platform downtime due to corrosion, and it is not unusual to lose more than 10% of an annual fleet availability due to corrosion. One recent study concluded that aircraft corrosion cost the Australian Defence Force $238M in 2013. Moreover, maintenance regimes also exist where two-thirds of scheduled inspections are for corrosion, and more damage is done by the resulting disassembly and reassembly of the structure than by actual material oxidation.

It is desired, therefore, to address or alleviate one or more difficulties of the prior art, or to at least provide a useful alternative.

### SUMMARY

In accordance with some embodiments of the present invention, there is provided an inspection apparatus for facilitating inspection of one or more relatively inaccessible inspection locations of a structure or second apparatus, said inspection apparatus including one or more guide sections mounted to said structure or second apparatus and configured to guide an inspection device along a path to access said inspection locations, and to allow inspection of said relatively inaccessible inspection locations of said structure or second apparatus by said inspection device.

In some embodiments, the said one or more guide sections includes a plurality of mutually spaced guide sections, wherein inspection of said relatively inaccessible inspection locations of said structure or second apparatus is performed by said inspection device via respective gaps between respective adjacent pairs of said mutually spaced guide sections.

In some embodiments, at least portions of said guide sections are configured to allow inspection of said relatively inaccessible inspection locations of said structure or second apparatus through said portions of said guide sections.

In some embodiments, said guide sections are mounted within said structure or second apparatus.

In some embodiments, at least one of said guide sections is curved or includes a curved portion to guide said inspection device along a corresponding curved portion of said path to access said inspection locations.

In some embodiments, said guide sections are configured to receive said inspection device.

In some embodiments, said guide sections are tubular in shape.

In some embodiments, each guide section includes an elongate portion that provides a corresponding portion of said path, and at least one end of each said guide section includes a corresponding capture feature configured to facilitate guidance of said inspection device to said elongate portion of said guide section from a corresponding one of said gaps between said guide section and a preceding guide section as said inspection device approaches said guide section from said preceding guide section.

In some embodiments, said guide sections are tubular in shape, and the capture feature includes an outwardly flared portion to guide said inspection device into the corresponding tubular guide section from the corresponding one of said gaps.

In some embodiments, at least one of said guide sections is curved or includes a curved portion to change a guide direction of the corresponding guide section.

In some embodiments, the relatively inaccessible inspection locations of said structure or second apparatus are internal cavities of a vessel.

In some embodiments, the relatively inaccessible inspection locations of said structure or second apparatus are within the wings or fuselage of an aircraft.

In some embodiments, the inspection device is configured for visual inspection of said inspection locations.

In some embodiments, the inspection device includes a borescope, industrial endoscope, videoscope, fiberscope, or other form of imaging device.

In some embodiments, the inspection apparatus includes said inspection device, wherein said inspection device includes at least one drive actuator configured to drive said inspection device along said path.

In some embodiments, said guide sections are configured to selectively engage with said inspection device to facilitate driving of said inspection device along said path.

In some embodiments, the inspection apparatus includes a drive cable normally disposed along said path for attachment to said inspection device to enable said inspection device to be pulled along said path.

In some embodiments, the inspection apparatus includes a conduit for selectively dispensing corrosion inhibiting compounds to said inspection locations.

In some embodiments, the inspection apparatus includes a remotely controllable actuator for selectively retrieving objects from said inspection locations.

In accordance with some embodiments of the present invention, there is provided an inspection method for facilitating inspection of one or more relatively inaccessible inspection locations of a structure or second apparatus, said method including mounting one or more guide sections to said structure or second apparatus so as to provide a path to access said inspection locations, said guide sections being configured to guide an inspection device along said path, and to allow inspection of said relatively inaccessible inspection locations of said structure or second apparatus by said inspection device.

In some embodiments, said one or more guide sections includes a plurality of mutually spaced guide sections, and inspection of said relatively inaccessible inspection locations of said structure or second apparatus is performed by said inspection device via respective gaps between respective adjacent pairs of said mutually spaced guide sections.

In some embodiments, at least portions of said guide sections are configured to allow inspection of said relatively inaccessible inspection locations of said structure or second apparatus through said portions of said guide sections.

In some embodiments, said guide sections are mounted within said structure or second apparatus.

In some embodiments, at least one of said guide sections is curved or includes a curved portion to guide said inspection device along a corresponding curved portion of said path to said inspection locations.

### BRIEF DESCRIPTION OF THE DRAWINGS

Preferred embodiments of the present invention are hereinafter described, by way of example only, with reference to the accompanying drawings, wherein:

FIG. 1 is a schematic diagram illustrating an inspection apparatus installed within a rear fuselage section of an aircraft, in accordance with an embodiment of the present invention.

### DETAILED DESCRIPTION

The described embodiments of the present invention include an inspection method and apparatus for facilitating the inspection of relatively inaccessible inspection locations of a structure or other apparatus. Although the embodiments are described in the context of performing visual inspections of a structure or apparatus, it should be understood that the meaning of the word “inspection” as used within this specification and claims is not limited to visual inspection, but includes any type of assessment that can be performed using any type of inspection device that can be used to assess the condition of an apparatus or structure.

The described inspection apparatus includes one or more guide sections mounted to the structure (or apparatus) to be inspected. Typically, these inspection locations will be located within the structure (or apparatus), but it is possible that at least some of the inspection locations may be located at or near a boundary, edge, or periphery of a structure that are not readily accessible. In any case, the guide sections are configured to guide an inspection device along a path to access the inspection locations, so that the inspection device is able to (visually or otherwise) inspect the inspection locations of the structure.

In some embodiments, at least portions of the guide sections are configured to allow inspection of the inspection locations through those portions of the guide sections. For example, where the inspection includes optical inspection, the portions of the guide sections can be made of a material that is transparent at relevant wavelengths. Alternatively, the guide sections may include openings (for example, in a wall of the guide sections) to allow the inspection locations to be accessed by the inspection device through those openings of the guide sections.

Alternatively or additionally, in some embodiments, the described inspection apparatus includes a plurality of mutually spaced guide sections so that the inspection device is able to inspect the inspection locations of the structure via the gaps between adjacent pairs of the guide sections.

In the described embodiments, the one or more guide sections are tubular, and the inspection device is guided by the wall(s) of the tubular guide sections as it moves through it or them, from each inspection location to the next. However, other alternative configurations will be apparent to those skilled in the art in light of this disclosure. For example, in some embodiments, the inspection device and the guide sections could include coupling components to couple the inspection device to the guide sections. The coupling components can be simple mechanical coupling components. For example, in one embodiment, the coupling components are in the form of ‘T’-shaped members that are slidingly engaged with the guide sections by way of elongate slots running along the length of the guide sections. The top of each “T” member is retained within the guide sections by being wider than the width of the slot, while the remainder protrudes through the slots, in the same manner as sliding curtain hangers are slidingly engaged with a slotted curtain rail. Many other suitable configurations will be apparent to those skilled in the art.

In some embodiments, each guide section includes an elongate portion that provides a corresponding portion of the path, and at least one end of each said guide section includes a corresponding capture feature configured to facilitate guidance of the inspection device to the elongate portion of said guide section as the inspection device traverses the gap from the preceding guide section. In some embodiments, the capture feature includes an outwardly flared portion that guides the inspection device into the corresponding tubular guide section from the corresponding gap.

In some embodiments, the inspection device can be inserted from either end of the path, and both ends of each guide section include capture features as described above. Alternatively, if the path through the structure is very long, it may be desirable to perform inspections over each half of the path separately, by inserting inspection device from respective ends of the path.

Typically, at least some of the guide sections are curved or include curved portions to change the direction of the inspection device as it moves along the path. Accordingly, the inspection apparatus can be used to inspect essentially any form of structure or apparatus, but is particularly advantageous when used to inspect locations within normally sealed or closed bays or cavities within a structure. In particular, the inspection apparatus can be applied to inspect internal bays or volumes within a vessel such as a marine vessel or aircraft. For example, the inspection apparatus can be permanently installed within the wings or fuselage of an aircraft to allow these internal spaces to be inspected by visual inspection device such as a borescope, industrial endoscope, videoscope, fiberscope, or other form of imaging device, without having to disassemble the structures. In normal use, the outermost ends of the guide sections are closed by respective caps or other forms of closure members, these being removed during inspection in order to allow the inspection device to be inserted into the structure from one end of the path defined by the guide sections, and, in some embodiments, to exit the structure from the other end of the path.

To enable it to traverse the path defined by the guide sections, the inspection device can be remotely driven, either by pushing it from the rear, or by pulling it from the front. For example, in some embodiments, a flexible driveshaft is used to push the inspection device through the guide sections from the ingress end of the path. Conversely, a flexible cable or draw string can be attached to the inspection device and used to pull it towards the egress end of the path. Pulling the borescope back out through the guide sections reverses the cable/draw string, returning it to its original location.

Alternatively, and in particular for paths that are very long and/or include a large number of bends, the drive means can be located at or near the front end of the inspection device, i.e., within the guide sections. In some embodiments, the inspection device includes a motor or drive actuator or mechanism mounted to the inspection device. To facilitate traversal of the path, the internal walls of the guide sections can be textured, patterned, or otherwise machined to enhance selective engagement by the drive mechanism. For example, in some embodiments of the inner walls of the guide sections are provided with a non-planar and asymmetrical surface configuration such as sawtooth indentations so that the engagement of the inner walls by the drive mechanism is enhanced to push the inspection device forwards along the path, and is diminished in the opposite direction. In embodiments where the inspection device is steerable, the inspection apparatus may provide multiple paths through a structure, including one or more branching paths where a single path provided by one guide section effectively splits into two paths after a gap so that an operator of the inspection apparatus can steer the inspection device into a selected one of multiple possible subsequent guide sections (and thus paths) following the gap.

In some embodiments, the guide sections include at least one conduit for selectively dispensing (e.g., by misting, fogging, etc) corrosion inhibiting compounds to the inspection locations. Alternatively, in some embodiments, the conduit is provided as part of the inspection device. In either configuration, locations requiring specific oxidation protection, or that are exhibiting precursors to corrosion, can be treated appropriately.

In some embodiments, the inspection device includes a remotely controllable actuator or manipulator that can be used to retrieve objects from the inspection locations. For example, foreign objects or drainage hole blockages can be retrieved by a clawed end-fixture, provided that the foreign object can fit within the tube or can be cut, broken, or otherwise divided up into pieces by the end-fixture and those pieces can fit within the tube. In some embodiments, the inspection device includes at least one flexible drive tool to allow a user of the inspection apparatus to adjust components such as fasteners or other adjustable components at or near the inspection locations.

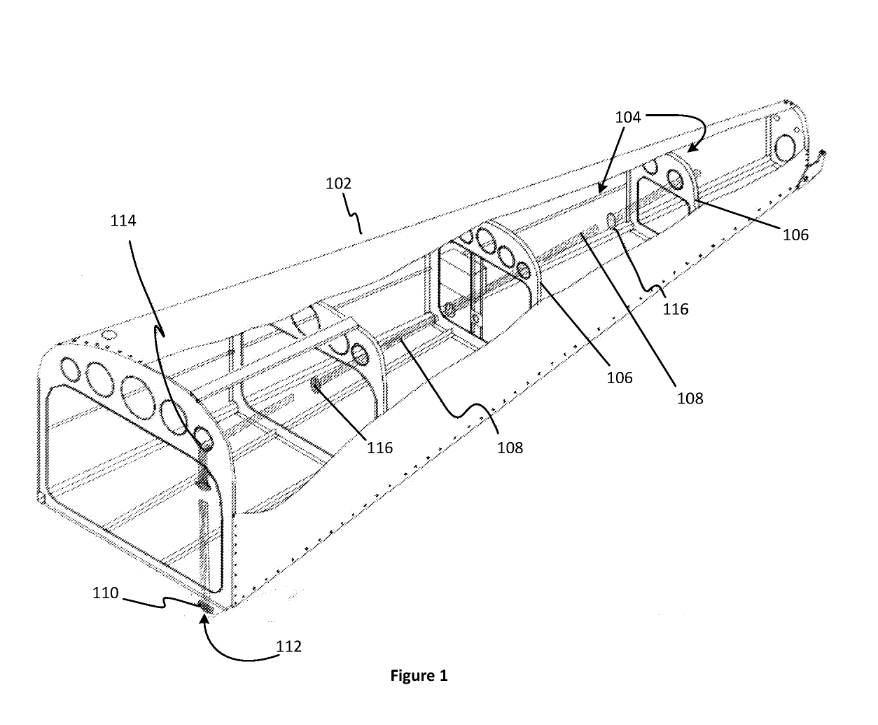

In one embodiment, as shown in FIG. 1, a rear fuselage section 102 of an aircraft includes a series of internal bays 104, separated by transverse structural members 106. In this example, the guide sections 108 are in the form of respective elongate tubes of circular cross-section permanently installed within the fuselage section 102 by mounting them along the inside wall of the fuselage 102. The guide sections 108 provide a path to access inspection locations located in the internal bays 104. The guide sections 108 are configured to receive a borescope (not shown) and to guide a borescope (or other form of optical scope or imaging device) along the path through the internal bays 104. Gaps between the mutually spaced guide sections 108 allow the borescope to view inspection locations within the internal bays 104, without having to disassemble the fuselage section 102 in any way, other than removing an end cap 110 that normally seals a dedicated inspection access port 112 in the fuselage section 102 at other times to maintain the normal isolated environment of the internal structure when the inspection apparatus is not in use.

To perform an inspection, the inspection device is thus inserted into the first of the guide sections via the dedicated entry port 112, which is provided at a readily accessible external location such as under an access hatch.

In this particular example, the path through the fuselage section 102 from the inspection access port 112 is linear except for a single 90° bend 114. However, it will be apparent that, in general, the path through a structure is essentially arbitrary, and in some instances might have no linear sections whatsoever.

It will also be apparent that there is only one gap between guide sections in each of the internal bays 104; however, in general the gaps can be located at any desired location, and there may be any number located within any given bay 104 (or other internal space, as appropriate). For example, multiple gaps within any single one of the bays 104 provide additional freedom for the inspection device to inspect different locations within that bay 104.

After each gap, a flared opening 116 at the entrance of the next guide section 108 guides and facilitates acceptance of the borescope into the next guide section 108, which in turn guides the inspection device into the next bay 104.

Many modifications will be apparent to those skilled in the art without departing from the scope of the present invention.

What is claimed is:

1. An inspection apparatus for facilitating inspection of one or more relatively inaccessible inspection locations of a structure or second apparatus, said inspection apparatus comprising one or more guide sections mounted to said structure or second apparatus and configured to guide an inspection device along a path to access said inspection locations, and to allow inspection of said relatively inaccessible inspection locations of said structure or second apparatus by said inspection device.

2. The inspection apparatus of claim 1, wherein said one or more guide sections includes a plurality of mutually spaced guide sections, wherein inspection of said relatively inaccessible inspection locations of said structure or second apparatus is performed by said inspection device via respective gaps between respective adjacent pairs of said mutually spaced guide sections.

3. The inspection apparatus of claim 1, wherein at least portions of said guide sections are configured to allow inspection of said relatively inaccessible inspection locations of said structure or second apparatus through said portions of said guide sections.

4. The inspection apparatus of claim 1, wherein said guide sections are mounted within said structure or second apparatus.

5. The inspection apparatus of claim 1, wherein at least one of said guide sections is curved or includes a curved portion configured to guide said inspection device along a corresponding curved portion of said path to access said inspection locations.

6. The inspection apparatus of claim 1, wherein said guide sections are configured to receive said inspection device.

7. The inspection apparatus of claim 6, wherein said guide sections are tubular in shape.

8. The inspection apparatus of claim 1, wherein:
each of the guide sections includes an elongate portion that provides a corresponding portion of said path: and
at least one end of each said guide section includes a corresponding capture feature configured to facilitate guidance of said inspection device to said elongate portion of said guide section from a corresponding one of said gaps between said guide section and a preceding guide section as said inspection device approaches said guide section from said preceding guide section.

9. The inspection apparatus of claim 8, wherein:
said guide sections are tubular in shape: and
the capture feature includes an outwardly flared portion configured to guide said inspection device into the corresponding tubular guide section from the corresponding one of said gaps.

10. The inspection apparatus of claim 1, wherein at least one of said guide sections is curved or includes a curved portion configured to change a guide direction of the corresponding guide section.

11. The inspection apparatus of claim 1, wherein the relatively inaccessible inspection locations of said structure or second apparatus are internal cavities of a vessel.

12. The inspection apparatus of claim 1, wherein the relatively inaccessible inspection locations of said structure or second apparatus are within the wings or fuselage of an aircraft.

13. The inspection apparatus of claim 1, wherein the inspection device is configured for visual inspection of said inspection locations.

14. The inspection apparatus of claim 1, wherein the inspection device includes a borescope, industrial endoscope, videoscope, fiberscope, or other form of imaging device.

15. The inspection apparatus of claim 1, further comprising said inspection device, wherein said inspection device includes at least one drive actuator configured to drive said inspection device along said path.

16. The inspection apparatus of claim 15, wherein said guide sections are configured to selectively engage with said inspection device to facilitate driving of said inspection device along said path.

17. The inspection apparatus of claim 1, further comprising a drive cable that is normally disposed along said path and configured for attachment to said inspection device, thereby enabling said inspection device to be pulled along said path.

18. The inspection apparatus of claim 1, further comprising a conduit configured for selectively dispensing corrosion inhibiting compounds to said inspection locations.

19. The inspection apparatus of claim 1, further comprising a remotely controllable actuator configured for selectively retrieving objects from said inspection locations.

20. An inspection method for facilitating inspection of one or more relatively inaccessible inspection locations of a structure or second apparatus, said method comprising mounting one or more guide sections to said structure or second apparatus so as to provide a path to access said inspection locations, said guide sections being configured to guide an inspection device along said path, and to allow inspection of said relatively inaccessible inspection locations of said structure or second apparatus by said inspection device.

21. The inspection method of claim 20, wherein:
said one or more guide sections includes a plurality of mutually spaced guide sections; and
inspection of said relatively inaccessible inspection locations of said structure or second apparatus is performed by said inspection device via respective gaps between respective adjacent pairs of said mutually spaced guide sections.

22. The inspection method of claim 20, wherein at least portions of said guide sections are configured to allow inspection of said relatively inaccessible inspection locations of said structure or second apparatus through said portions of said guide sections.

23. The inspection method of a claim 20, wherein said guide sections are mounted within said structure or second apparatus.

24. The inspection method of claim 20, wherein at least one of said guide sections is curved or includes a curved portion to guide said inspection device along a corresponding curved portion of said path to said inspection locations.
